(19) United States
(12) Patent Application Publication
(10) Pub. No.: US 2019/0001794 A1
(43) Pub. Date: Jan. 3, 2019

(54) VEHICLE WINDOW SHADE SYSTEM

(71) Applicant: Michael Gonzalez, Garland, TX (US)

(72) Inventor: Michael Gonzalez, Garland, TX (US)

(21) Appl. No.: 16/021,728

(22) Filed: Jun. 28, 2018

Related U.S. Application Data
(60) Provisional application No. 62/525,975, filed on Jun. 28, 2017.

(51) Int. Cl. B60J 1/20

(52) U.S. Cl. CPC B60J 1/2052; B60J 1/2038; B60J 1/2047; B60J 1/2077; B60J 1/2063

(57) ABSTRACT

A vehicle window shade system to seal the widow area from the rest of the vehicle. The shade is stored in the dash and extends upward via tracks on the window posts. The screen is sealed at the top to the headliner. The screen is stored in a container in the dashboard.

### BACKGROUND

### 1. Field of the Invention

The present invention relates generally to window shades, and more specifically, to a vehicle window shade system for reducing that amount of sunlight that enters a vehicle while not in use.

### 2. Description of Related Art

Window shades are well known in the art and are effective means to block light from entering a space such as room or car. For example, FIG. 1 depicts a conventional folding window shade device 101 having a series of panels 103 hingedly attached to each other to form a screen 105. During use, the screen 105 is expanded and placed in the window 107 of a car 109 as depicted by motion A.

One of the problems commonly associated with system 101 is its limited efficiency. For example, the screen 105 does not cover the entire window 107 allowing light and heat to enter the car around the edges or wherever the screen 105 does not cover the window 107.

Accordingly, although great strides have been made in the area of window shades, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common folding window shade device;

FIG. 2 is a front view of a vehicle window shade system in accordance with a preferred embodiment of the present application; and

FIG. 3 is a cross-sectional side view of the screen of FIG. 2;

FIG. 4 is s cross-sectional side view of the system of FIG. 2 in use;

FIG. 5 is a flowchart of the preferred method of use of the system FIG. 2; and

FIG. 6 is a side view of an alternative embodiment of the screen of FIG. 2.

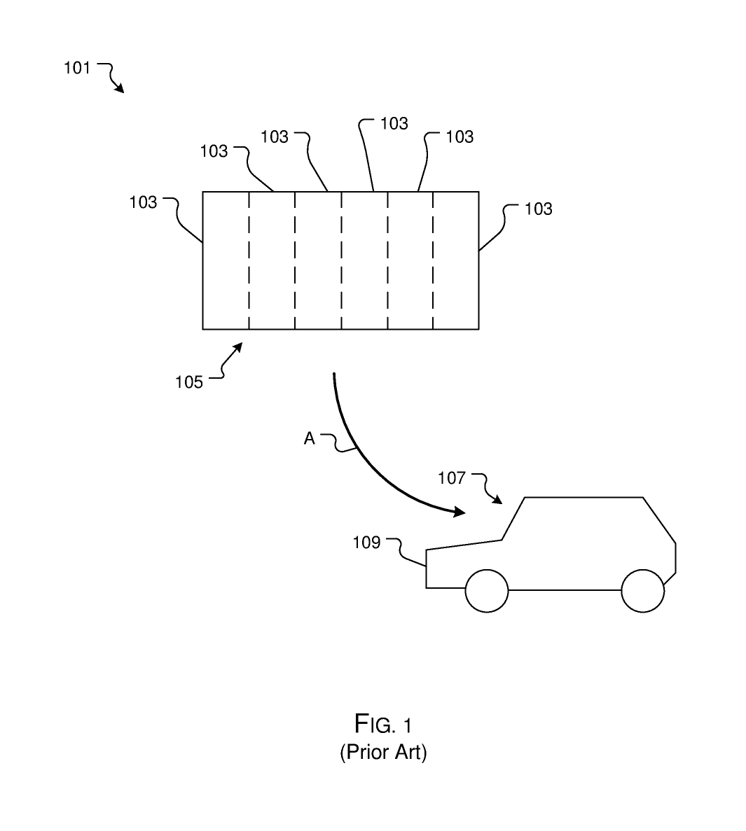

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional folding window shade devices. Specifically, the system of the present application prevents the entry of light or heat into a vehicle through the protected window. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

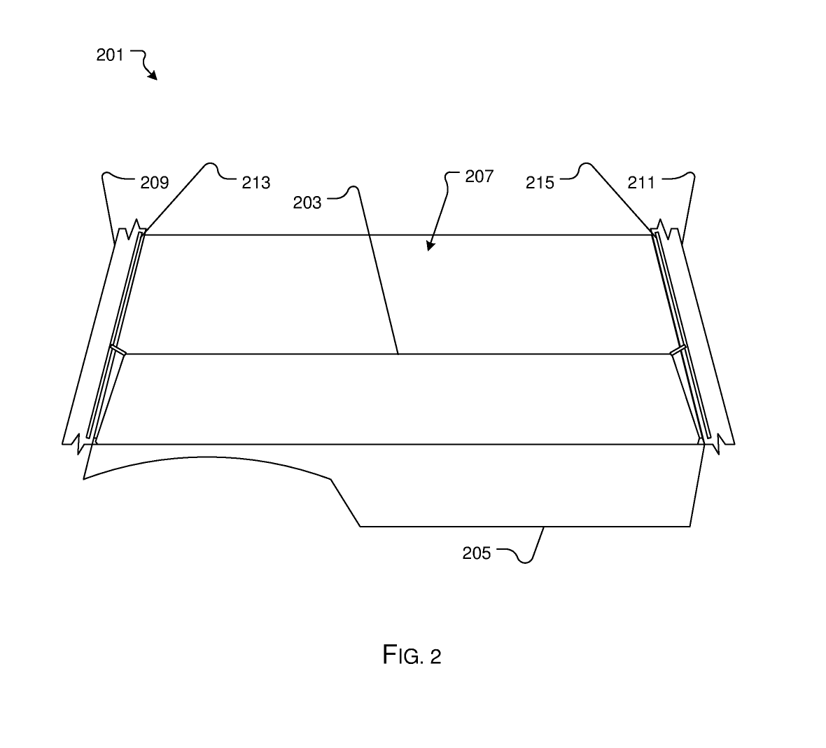

Referring now to the drawings wherein like reference characters identify corresponding or similar elements throughout the several views, FIG. 2 depicts a front view of a vehicle window shade system in accordance with a preferred embodiment of the present application. It will be appreciated that system 201 overcomes one or more of the above-listed problems commonly associated with conventional folding window shade devices.

In the contemplated embodiment, system 201 includes a screen 203, stored in the dash board 205 of a vehicle. The screen 203 is attached to the posts 209, 211 on either side of a window 207 via a track 213, 215 respectively. The screen 203 is raised and lowered by the tracks 213, 215.

The screen 203 is stored in a compartment 303 concealed within the dashboard 205 by a door 301 as depicted in FIG. 3. The screen 203 is anchored within the compartment 303 so that when extended is remains attached.

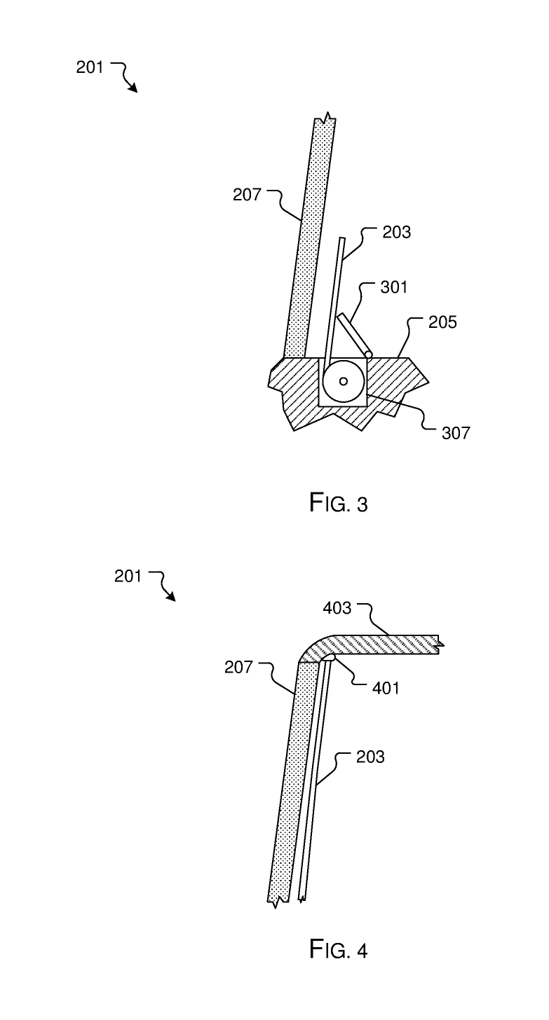

Referring now to FIG. 4, the screen 203, when extended is attached to the headliner 403 of the vehicle via seal 401.

It should be appreciated that one of the unique features believed characteristic of the present application is that screen 203 is attached to the posts 209, 211 of the window 213 which enables the screen 203 to seal off the window 213 via seal 405.

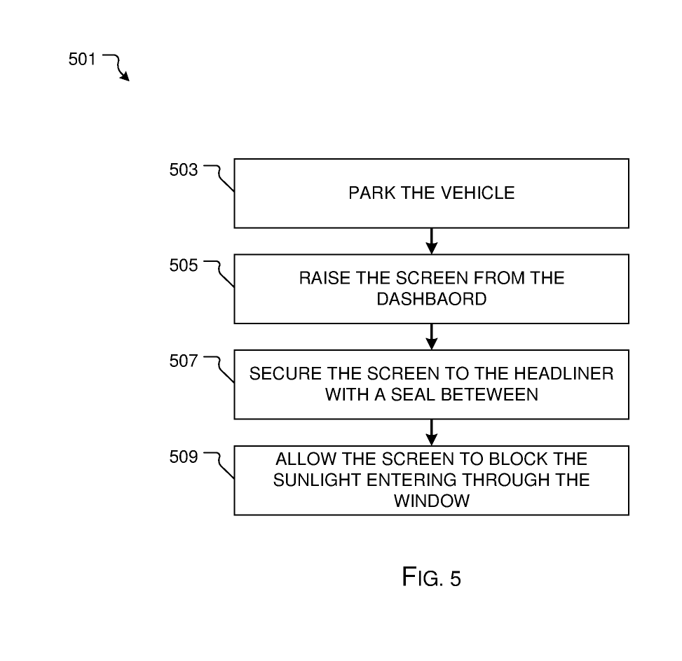

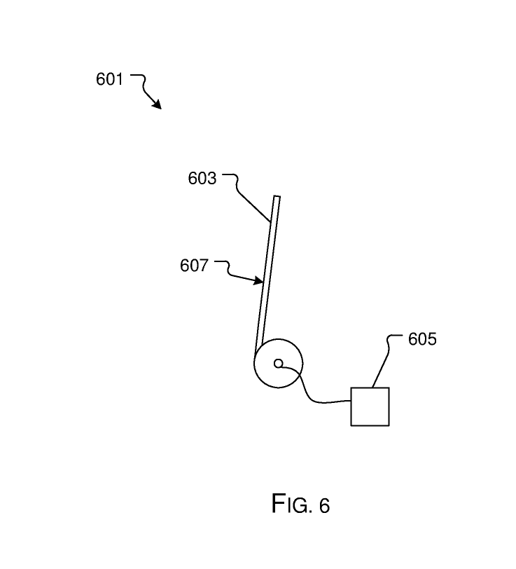

Referring now to FIG. 5 the preferred method of use of the system 201 is depicted. Method 501 including parking the vehicle 503, raising the screen from the dashboard 505, securing the screen to the headliner via a seal 507 and allowing the screen to block the sunlight that enters a window 509.

Referring now to FIG. 6 an alternative embodiment of the screen 203 is depicted. Embodiment 601 including a first layer 603 having an outer surface 607 capable of absorbing solar energy and transforming it to a form of potential energy. The first layer 603 is electric communication with a battery 605.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A vehicle window shade system comprising:
a screen attached in a container in the dashboard;
tracks attached to the posts on both sides of a window configured to raise and lower the screen; and
a seal attached to the headliner;
wherein the area between the window screen is seal off from the rest of the space in the vehicle.

2. The system of claim 1 wherein the screen has a first layer that is capable of capturing solar energy.

3. The system of claim 2 wherein the captured energy is transferred to a battery.
